(19) United States
(12) Patent Application Publication
(10) Pub. No.: US 2018/0070268 A1
(43) Pub. Date: Mar. 8, 2018

(54) CONTROL ENTITY AND METHOD THEREOF

(71) Applicant: NEC Corporation, Tokyo (JP)

(72) Inventors: Takanori IWAI, Tokyo (JP); Tetsuo INOUE, Tokyo (JP)

(73) Assignee: NEC Corporation, Tokyo (JP)

(21) Appl. No.: 15/561,589

(22) PCT Filed: Mar. 11, 2016
(86) PCT No.: PCT/JP2016/001366

§ 371 Date: Sep. 26, 2017

(30) Foreign Application Priority Data
Mar. 30, 2015 (JP) 2015-069029

(51) Int. Cl. H04W 28/22; H04W 8/18; H04W 28/02

(52) U.S. Cl. CPC H04W 28/22; H04W 92/04; H04W 28/02; H04W 8/18

(57) ABSTRACT

A control entity (1) receives, from an application layer entity (3), first information regarding a communication pattern of a wireless terminal and provides the first information or a network parameter derived therefrom to a network entity (2). The control entity (1) further performs communication control regarding transmission or reception of the first information. The communication control includes at least one of: filtering a plurality of notification messages each carrying the first information in accordance with a filtering rule; requesting the application layer entity (3) to set or change a transmission policy of the first information; and applying different priority levels to the plurality of notification messages.

### TECHNICAL FIELD

The disclosure of the present specification relates to a mobile communication network and, in particular, to a control entity for exposing services and capabilities provided by network entities in a mobile communication network to external application providers.

### BACKGROUND ART

3GPP TR 23.708 (Non-Patent Literature 1) discloses an architecture that includes a function for exposing the services and capabilities provided by network entities in a mobile communication network to external application providers. This function is referred to as a Service Capability Exposure Function (SCEF). The SCEF provides means to securely expose the services and capabilities, which are provided through 3GPP network interfaces from 3GPP network entities, to the external application providers. The SCEF provides access to network capabilities through network application programming interfaces (APIs). These network APIs may be defined by, for example, Open Mobile Alliance (OMA), Global System for Mobile Communications Association (GSMA), or other standardization bodies.

Non-Patent Literature 1 further discloses optimization of network resources in a mobile communication network (i.e., 3GPP network) based on information regarding communication patterns of wireless terminals (User Equipment (UEs)) provided by an external application provider(s). To be more specific, the SCEF receives information regarding communication patterns of UEs from an external application provider(s). The SCEF derives a network parameter(s) for a network entity(ies) (e.g., core network node(s)) from the received information regarding the communication patterns and provides the derived network parameter(s) to an appropriate network entity(ies).

The communication patterns of the UE received by the SCEF from the application provider(s) includes, for example, a data traffic communication pattern or mobility communication pattern or both. Examples of the data traffic communication pattern include an indicator indicating whether the communication is periodic (i.e., periodic communication indicator), a communication duration time, a communication period (periodic time), a scheduled communication time, and an average data volume per communication. Examples of the mobility communication pattern include a stationary indication indicating whether it is stationary, a stationary location, a mobility area (e.g., a list of cells, a list of tracking areas (TAs)), and an average moving (or mobility) speed.

For example, the SCEF receives information regarding one or both of the data traffic communication pattern and mobility communication pattern from the application provider(s) and provides this information or a network parameter(s) derived therefrom to a Mobility Management Entity (MME) via a Home Subscriber Server (HSS). For example, the MME derives Expected UE Activity Behaviour based on the data traffic communication pattern. The Expected UE Activity Behaviour includes, for example, an average time the UE remains in ECM-CONNECTED and an average time the UE remains in ECM-IDLE. The MME may derive an Expected Handover Interval based on the mobility communication pattern. The Expected Handover Interval indicates an expected time interval of inter-base station (i.e., inter-eNB) handovers. The information derived by the MME including the Expected UE Activity Behaviour and the Expected Handover Interval is referred to as Core Network Assistance Information (CN Assistance Information).

The MME provides the CN assistance information regarding a UE to the base station (i.e., eNB) during the setup of the S1 signaling connection in response to attach or service request from the UE. The eNB uses the CN assistance information, for example, to reduce the number of transitions between CONNECTED and IDLE.

### CITATION LIST

### Non-Patent Literature

Non-Patent Literature 1: 3GPP TR 23.708 V1.1.0 (2015 February), “3rd Generation Partnership Project; Technical Specification Group Services and System Aspects; Architecture Enhancements for Service Capability Exposure (Release 13)”, February 2015

### SUMMARY OF INVENTION

### Technical Problem

As described above, in some implementations, the SCEF receives the communication pattern information from the external application provider(s). However, there is a possibility that a transmission rate of the communication pattern information by the external application provider(s) or a trigger condition (e.g., threshold) triggering the transmission of the communication pattern information may not be properly set. For example, an excessive transmission rate of the communication pattern information from the external application provider may cause the load of the SCEF or 3GPP network to be increased. Moreover, if the trigger condition for transmitting the communication pattern information is inappropriate, the optimization of the network resources may not be properly performed.

One of the objects to be attained by embodiments disclosed herein is to provide an apparatus, a method, and a program that contribute to enabling a control entity (e.g., SCEF) providing an interface to an external application provider to properly receive communication pattern information. Note that this object is only one of the objects to be attained by the embodiments disclosed herein. The other objects or problems and novel features will be made apparent from the following description and the accompanying drawings.

### Solution to Problem

In a first aspect, a control entity includes a memory and at least one processor coupled to the memory. The at least one processor is configured to communicate with at least one network entity in a mobile communication network. The at least one processor is configured to provide at least one interface to enable at least one application layer entity to use a service provided by the mobile communication network. The at least one processor is configured to receive first information regarding a communication pattern of a wireless terminal via the at least one interface. The at least one processor is configured to provide the first information or a network parameter derived from the first information to the at least one network entity. Further, the at least one processor is configured to perform communication control regarding transmission or reception of the first information. The communication control includes at least one of: (a) filtering a plurality of notification messages each carrying the first information in accordance with a filtering rule; (b) requesting the at least one application layer entity to set or change a transmission policy of the first information; and (c) applying different priority levels to the plurality of notification messages.

In a second aspect, a method performed by a control entity includes: receiving first information regarding a communication pattern of a wireless terminal from at least one application layer entity via at least one interface; providing the first information or a network parameter derived from the first information to at least one network entity; and performing communication control regarding transmission or reception of the first information. The communication control includes at least one of: (a) filtering a plurality of notification messages each carrying the first information in accordance with a filtering rule; (b) requesting the at least one application layer entity to set or change a transmission policy of the first information; and (c) applying different priority levels to the plurality of notification messages.

In a third aspect, a program includes instructions (software codes) that, when loaded into a computer, causes the computer to perform the method according to the above-described second aspect.

### Advantageous Effects of Invention

According to the above aspects, it is possible to provide an apparatus, a method, and a program that contribute to enabling a control entity (e.g., SCEF) providing an interface to an external application provider to properly receive communication pattern information.

### BRIEF DESCRIPTION OF DRAWINGS

FIG. 1 is a diagram showing a configuration example of a network including a control entity according to some embodiments;

FIG. 2 is a sequence diagram showing an example of a control procedure according to a first embodiment;

FIG. 3 is a flowchart showing an example of an operation of a control entity according to the first embodiment;

FIG. 4 is a flowchart showing an example of an operation of the control entity according to the first embodiment;

FIG. 5 is a flowchart showing an example of an operation of the control entity according to the first embodiment;

FIG. 6 is a sequence diagram showing an example of a control procedure according to a second embodiment;

FIG. 7 is a flowchart showing an example of an operation of a control entity according to a third embodiment;

FIG. 8 is a sequence diagram showing an example of a control procedure according to the third embodiment;

FIG. 9 is a sequence diagram showing an example of a control procedure according to the third embodiment; and

FIG. 10 is a block diagram showing an example of a configuration of a control entity according to some embodiments.

### Description of Embodiments

Hereinafter, specific embodiments will be described in detail with reference to the drawings. The same or corresponding elements are denoted by the same reference signs throughout the drawings, and repeated descriptions will be omitted as necessary for the sake of clarity.

Embodiments described below will be explained mainly using specific examples with regard to a Long Term Evolution (LTE)/LTE-Advanced system. However, these embodiments are not limited to the LTE/LTE-Advanced system and may be applied to other mobile communication networks or systems, for example, a 3GPP Universal Mobile Telecommunications System (UMTS), a 3GPP2 CDMA2000 system, a Global System for Mobile communications (GSM (registered trademark))/General packet radio service (GPRS) system, and a WiMAX system.

### First Embodiment

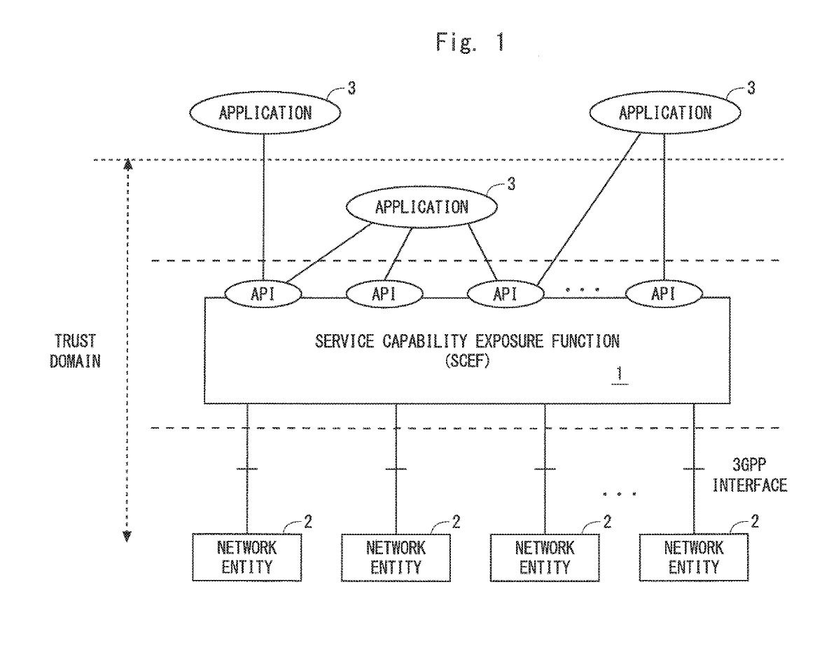

FIG. 1 shows a configuration example of a mobile communication network according to some embodiments including this embodiment. A Service Capability Exposure Function (SCEF) entity 1 is a control entity that operates to expose services and capabilities provided by one or more network entities 2 in a mobile communication network to one or more application layer entities 3. The SCEF 1 securely exposes, to the application layer entity(ies) 3, the services and capabilities provided by the network entity(ies) 2 through a 3GPP network interface(s). The SCEF entity 1 provides access to network capabilities via network application programming interfaces (APIs).

Each network entity 2 is connected to the SCEF entity 1 via a 3GPP interface and provides the application layer entity(ies) 3 with services and capabilities via the SCEF entity 1. The one or more network entities 2 include a control plane entity(ies) of the 3GPP network, for example, at least one of an HSS, an MME, a Serving GPRS Support Node (SGSN), a Policy and Charging Rule Function (PCRF), a Short Message Service-Service Centre (SMS-SC), a Call Session Control Function (SCSF), and a Machine Type Communication Inter Working Function (MTC-IWF). The one or more network entities 2 may further include a user plane (or data plane) entities of the 3GPP network such as a Serving Gateway (S-GW) and a Packet Data Network Gateway (P-GW). The one or more network entities 2 may further include entities related to network resource optimization, for example, an Operation Administration and Maintenance (OAM) server, a Software-Defined Network (SDN) controller, and a Self-Organizing Network (SON)/Element Management System (EMS).

Each application layer entity 3 communicates with the SCEF entity 1 via one or more APIs. Each application layer entity 3 may be referred to as an application server (AS), sometimes referred to as an application provider, and sometimes simply referred to as an application.

The SCEF entity 1 is controlled by a mobile operator (3GPP operator) or controlled by a business partner, for example another operator or third party trusted by the 3GPP operator. Each application layer entity 3 may be controlled by the 3GPP operator or controlled by a business partner, for example another operator or third party trusted by the 3GPP operator. Alternatively, each application layer entity 3 may be controlled by a third party. The trust domain shown in FIG. 1 indicates a range controlled by the 3GPP operator and its business partners.

Note that the SCEF entity 1 according to this embodiment means a functional entity. The SCEF entity 1 may include a plurality of sub-functional entities. The SCEF entity 1 may be implemented using a plurality of physical entities (i.e., computers and network devices). An intermediation framework between the network entities 2 and the application layer entities 3, like the SCEF entity 1, is sometimes referred to as a service platform. Further, in OMA, a framework providing APIs to the application layer entities 3, like the SCEF entity 1, is referred to as an Exposure Layer.

Hereinafter, a configuration and an operation of the SCEF entity 1 will be described in detail. The SCEF entity 1 is configured to receive from the one or more application layer entities 3, via the one or more APIs, information regarding a communication pattern of a wireless terminal (UE) (i.e., communication pattern information). The SCEF entity 1 is further configured to provide the one or more network entities 2 with the received communication pattern information, or a network parameter(s) derived therefrom, or both.

The communication pattern information received by the SCEF entity 1 includes, for example, one or both of a data traffic communication pattern and a mobility communication pattern. As has been described above, examples of the data traffic communication pattern include an indicator indicating whether the communication is periodic (i.e., periodic communication indicator), a communication duration time, a communication period (i.e., periodic time), a scheduled communication time, and an average data volume per communication. Examples of the mobility communication pattern include a stationary indication indicating whether it is stationary, a stationary location, a mobility area (e.g., a list of cells or a list of tracking areas (TAs)), and an average mobility speed.

The network parameters derived from the communication pattern information by the SCEF entity 1 may be Expected UE Behaviour information. The Expected UE Behaviour information includes at least one of Expected UE Activity Behaviour and Expected Handover Interval. As has been described above, the Expected UE Activity Behaviour includes, for example, an average time the UE remains in ECM-CONNECTED and an average time the UE remains in ECM-IDLE. The Expected Handover Interval indicates an expected time interval of inter-base station (i.e., inter-eNB) handovers. The SCEF entity 1 may communicate with the HSS to obtain the network parameter(s) derived from the communication pattern information.

Furthermore, the SCEF entity 1 is configured to perform communication control regarding transmission or reception of the communication pattern information. The communication control relates to at least one of transmission of the communication pattern information by the application layer entity(ies) 3 and reception of the communication pattern information by the SCEF entity 1. The communication control may be performed by enforcing or applying a transmission policy of the communication pattern information to the application layer entity(ies) 3. Additionally or alternatively, the communication control may be performed by enforcing or applying a reception policy of the communication pattern information to the SCEF entity 1. The transmission policy is a constraint(s) imposed (or applied) on the transmission of the communication pattern information, and the reception policy is a constraint(s) imposed (or applied) on the reception of the communication pattern information.

In some implementations, the communication control by the SCEF entity 1 may include filtering a plurality of notification messages each carrying the communication pattern information in accordance with a filtering rule. The filtering rule is an example of the reception policy. The filtering may completely block the reception from a particular application layer entity(ies) 3 or the reception of a particular type(s) of the communication pattern information. Alternatively, the filtering may lower the reception rate.

In some implementations, the communication control by the SCEF entity 1 may include requesting the one or more application layer entities 3 to set or change the transmission policy of the communication pattern information. The transmission policy includes, for example, at least one of the transmission rate and a transmission trigger condition (e.g., threshold). The transmission trigger condition may be, for example, that a predetermined parameter (e.g., average communication duration time, average communication interval, or average moving (or mobility) speed) or an amount of change in the predetermined parameter exceeds a threshold. The transmission trigger condition may be that a duration during which the predetermined parameter or the amount of change in the predetermined parameter exceeds the threshold exceeds a predetermined hold time. The hold time is sometimes referred to as a guard time or a Time to Trigger (TTT).

In some implementations, the communication control by the SCEF entity 1 may include applying different priority levels to the notification messages. The priority levels are an example of the reception policy or the transmission policy. For example, the SCEF entity 1 may receive the notification messages each carrying the communication pattern information from a first application layer entity more frequently than notification messages from a second application layer entity which has a lower priority level than the first application layer entity. In order to apply the priority levels, the SCEF entity 1 may adjust the reception policy such as the filtering rule or the transmission policy such as the transmission rate and the transmission trigger condition.

The SCEF entity 1 may perform the communication control (e.g., policy enforcement) per application layer entity 3, per message type (per type of the communication pattern information), per UE, or per group of UEs (UE group). For example, the UE groups may be defined based on the UE types or may be defined based on applications or services used by UEs. The SCEF entity 1 may further determine the setting or changing of the communication control regarding the reception or transmission of the communication pattern information (e.g., setting or changing of the reception or transmission policy) in the following manner.

In some implementations, the SCEF entity 1 may be configured, when the reception rate (reception frequency) of the communication pattern from a certain application layer entity 3 exceeds a reference rate, to change the communication control (e.g., the reception or transmission policy) regarding the application layer entity 3 or regarding the type of the communication pattern information. For example, the SCEF entity 1 may discard or ignore the communication pattern information exceeding the reference rate in accordance with the filtering rule. In this case, the SCEF entity 1 may return a rejection message to the sender application layer entity 3. Alternatively, in order to reduce the transmission rate, the SCEF entity 1 may transmit to the sender application layer entity 3 a request to lower the transmission rate of the communication pattern information or a request to change the transmission trigger condition regarding the communication pattern information . By doing so, the load on the SCEF entity 1 and the one or more network entities 2 can be reduced.

In some implementations, the SCEF entity 1 may be configured to determine the communication control (e.g., policy) regarding the communication pattern information based on a network performance indicator. The network performance indicator represents an effect of network optimization (e.g., network resource optimization) performed based on the communication pattern information from the one or more application layer entities 3. The network performance indicator relates, for example, to at least one of a paging failure rate, the number of CONNECTED-IDLE state transitions, the number of receptions of a connection request (e.g., Service Request) to transition from an IDLE state to a CONNECTED state, and the number of connection rejections based on Non-Access Stratum (NAS) back-off.

By considering the network performance indicator, i.e., by considering a result of the network resource optimization, when determining the communication control regarding the reception or transmission of the communication pattern information (e.g., reception or transmission policy), the SCEF entity 1 can preferentially treat the application layer entity 3, the communication pattern type, the UE, or the UE group, which contributes greatly to the network resource optimization. For example, the SCEF entity 1 may give a higher priority level, increase the transmission rate, or relieve the transmission trigger condition applied to the application layer entity 3 or the communication pattern information type which contributes greatly to the network resource optimization (i.e., contributes greatly to performance improvement), upon considering the network performance indicator. On the contrary, the SCEF entity 1 may give a lower priority level, decrease the transmission rate, or aggravate the transmission trigger condition applied to the application layer entity 3 or the communication pattern information type which contributes less to the network resource optimization (i.e., contributes less to performance improvement).

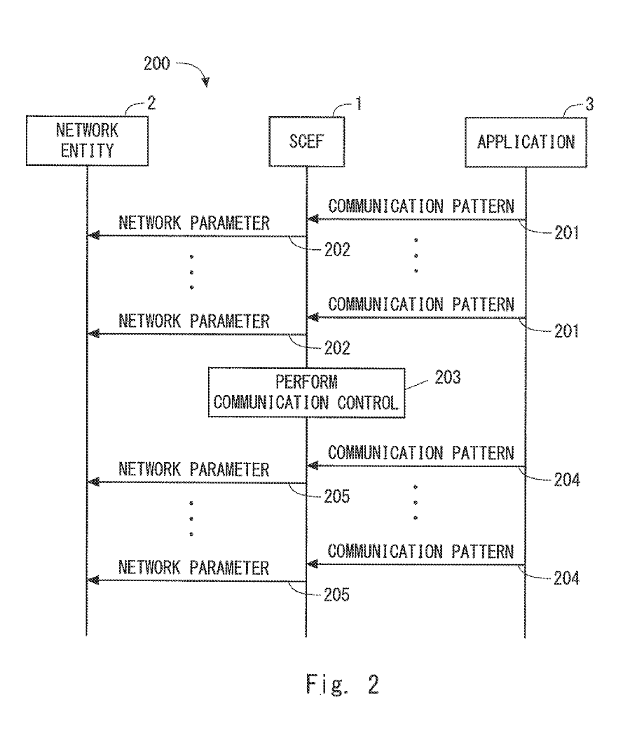

FIG. 2 is a sequence diagram showing an example (process 200) of a communication control procedure regarding the reception or transmission of the communication pattern information. In Block 201, the SCEF entity 1 receives messages each carrying the communication pattern information from the one or more application layer entities 3. In Block 202, the SCEF entity 1 transmits the network parameter(s) derived from the received communication pattern information to the one or more network entities 2. The network entity(ies) 2 may use the received network parameter(s), for example, to perform optimization of the network resources (e.g., tuning by the base station (eNodeB) of a parameter(s) regarding CONNECTED-IDLE state transitions). The SCEF entity 1 may transmit the network parameter(s) to the HSS which is one of the network entities 2.

In Block 203, the SCEF entity 1 performs the communication control (e.g., enforcement of the reception or transmission policy) regarding the reception or transmission of the communication pattern information (or the messages each carrying the communication pattern information). As has been described above, the SCEF entity 1 may consider a reception history of the communication pattern information (e.g., reception rate or reception frequency in the past) or a result of the network resource optimization based on the communication pattern information, when determining how to perform the communication control (e.g., the reception or transmission policy). In Block 204, the SCEF entity 1 receives messages each carrying the communication pattern information from the one or more application layer entities 3 in accordance with the executed communication control. In Block 205, the SCEF entity 1 transmits the network parameter(s) derived from the received communication pattern information to the one or more network entities 2.

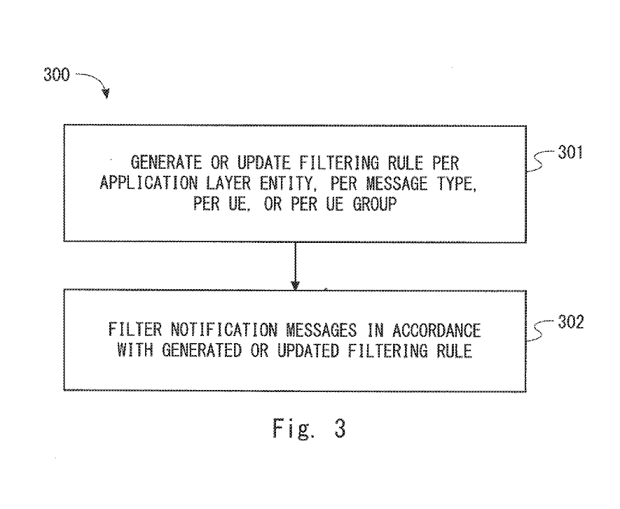

FIG. 3 is a flowchart showing an example (process 300) of an operation of the communication control by the SCEF entity 1. In Block 301, the SCEF entity 1 generates or updates the filtering rule per application layer entity 3, per message type (or communication pattern information type), per UE, or per UE group. In Block 302, the SCEF entity 1 filters the notification messages (each carrying the communication pattern information) sent from the one or more application layer entities 3 in accordance with the generated or updated filtering rule.

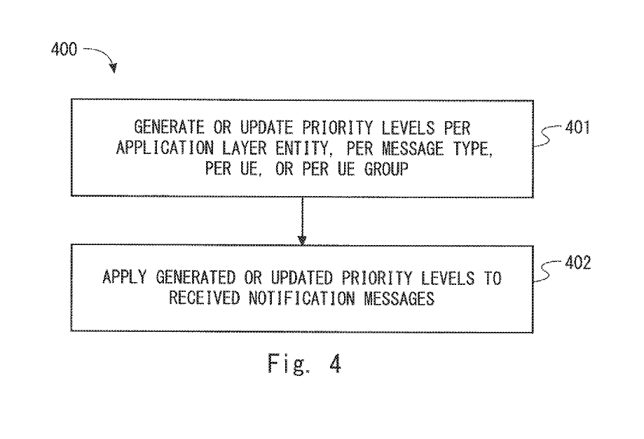

FIG. 4 is a flowchart showing an example (process 400) of the operation of the communication control by the SCEF entity 1. In Block 401, the SCEF entity 1 generates or updates the priority levels per application layer entity 3, per message type (or communication pattern information type), per UE, or per UE group. In Block 402, the SCEF entity 1 applies the generated or updated priority levels to the notification messages (each carrying the communication pattern information) sent from one or more application layer entities 3.

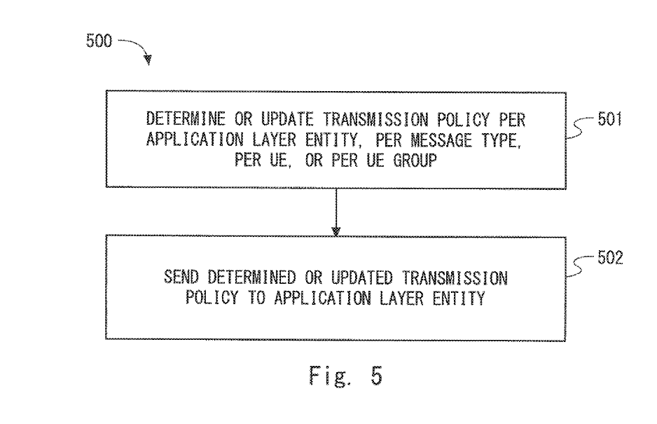

FIG. 5 is a flowchart showing an example (process 500) of the operation of the communication control by the SCEF entity 1. In Block 501, the SCEF entity 1 generates or updates the transmission policy per application layer entity 3, per message type (or communication pattern information type), per UE, or per UE group. The transmission policy relates, for example, to at least one of the transmission rate and the transmission trigger condition. In Block 502, the SCEF entity 1 sends the generated or updated transmission policy to the one or more application layer entities 3 to enforce the transmission policy.

As understood from the above description, the SCEF entity 1 according to this embodiment is configured to execute the communication control regarding the reception of the communication pattern information by the SCEF entity 1 or the transmission of the communication pattern information by the one or more application layer entities 3. Therefore, the SCEF entity 1 can properly receive the communication pattern information.

### Second Embodiment

This embodiment provides a specific example of the communication control using the result of network resources optimization. A configuration example of the mobile communication network according to this embodiment is the same as that in FIG. 1.

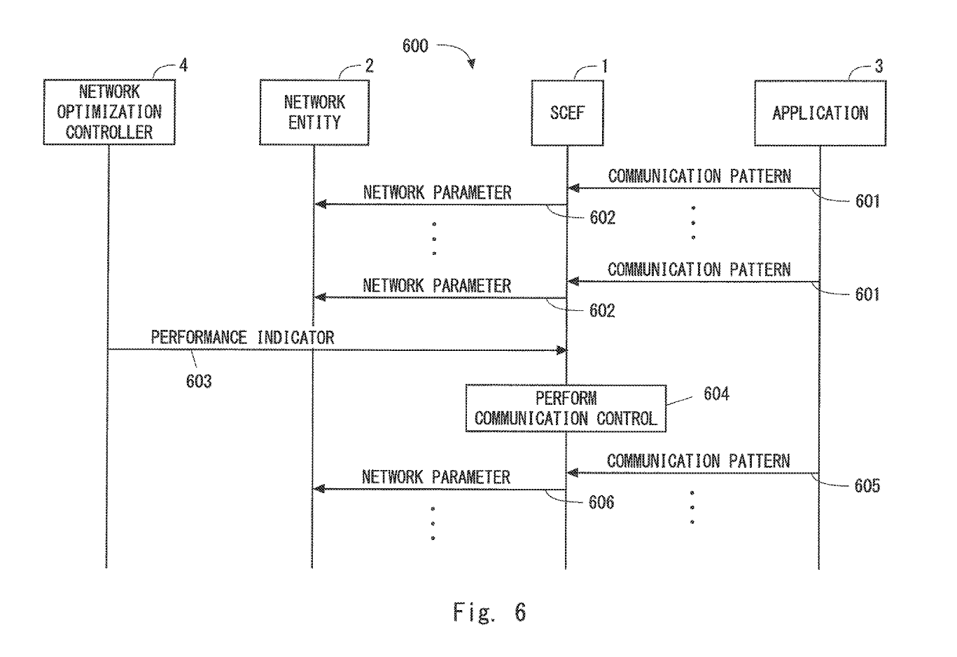

FIG. 6 is a sequence diagram showing an example (process 600) of a communication control procedure regarding the reception or transmission of the communication pattern information. In Block 601, the SCEF entity 1 receives messages each carrying the communication pattern information from the one or more application layer entities 3. In Block 602, the SCEF entity 1 transmits a network parameter(s) derived from the received communication pattern information to the one or more network entities 2. The one or more network entities 2 use the received network parameter(s) to perform network resource optimizations (e.g., tuning by the base station (eNodeB) of a parameter(s) regarding CONNECTED-IDLE state transitions). The network resource optimization may be performed by a network entity 2 (e.g., MME, OAM, SON/EMS) other than the network entity 2 (e.g., HSS) that directly receives the network parameter(s) from the SCEF entity 1.

In Block 603, the SCEF entity 1 receives a network performance indicator from a network optimization controller 4. The network performance indicator indicates a result of the network resource optimization based on the communication pattern information (601) or network parameters (602) derived therefrom. The network optimization controller 4 may be, for example, an OAM server. The SCEF entity 1 may receive the network performance indicator from one of the network entities 2 instead of receiving it from the network optimization controller 4. As has been described above, the network performance indicator relates, for example, to at least one of a paging failure rate, the number of CONNECTED-IDLE state transitions, the number of receptions of a connection request (e.g., Service Request) to transition from an IDLE state to a CONNECTED state, and the number of connection rejections based on Non-Access Stratum (NAS) back-off.

In Block 604, the SCEF entity 1 generates or updates the contents of the communication control regarding the reception or transmission of the communication pattern information (e.g., the reception or transmission policy) based on the received network performance indicator and then executes the communication control. In Block 605, the SCEF entity 1 receives messages each carrying the communication pattern information from the one or more application layer entities 3 in accordance with the executed communication control. In Block 606, the SCEF entity 1 transmits the network parameter(s) derived from the received communication pattern information to the one or more network entities 2.

As understood from the above description, the SCEF entity 1 according to this embodiment is configured to consider a result of the network resource optimization based on the communication pattern information, when determining how to perform the communication control regarding the reception or transmission of the communication pattern information and determining the execution of the communication control. Accordingly, the SCEF entity 1 can preferentially treat the application layer entity 3 or communication pattern type which contributes greatly to the network resource optimization

### Third Embodiment

This embodiment provides a modified example of the communication control regarding the reception or transmission of the communication pattern information. A configuration example of the mobile communication network according to this embodiment is the same as that in FIG. 1. The SCEF entity 1 of this embodiment is configured to determine the transmission policy based on UE default characteristics and send the determined transmission policy to the one or more application layer entities 3. The transmission policy relates, for example, to at least one of the transmission rate and the transmission trigger condition.

The UE default characteristics indicate data traffic characteristics or mobility characteristics of a UE in normal situations. The UE default characteristics may be a data traffic communication pattern, or a mobility communication pattern, or reference values (default values) of both. The UE default characteristics may include, for example, a communication duration time, a communication period (or periodic time), or an acceptable delay time, or any combination thereof. Additionally or alternatively, the UE default characteristics may include, for example, a size of a mobility area, or a moving speed, or a combination thereof. The SCEF entity 1 may determine, for example, at least one of a threshold and a hold time included in the transmission trigger condition, based on the reference value(s) indicated by the UE default characteristics.

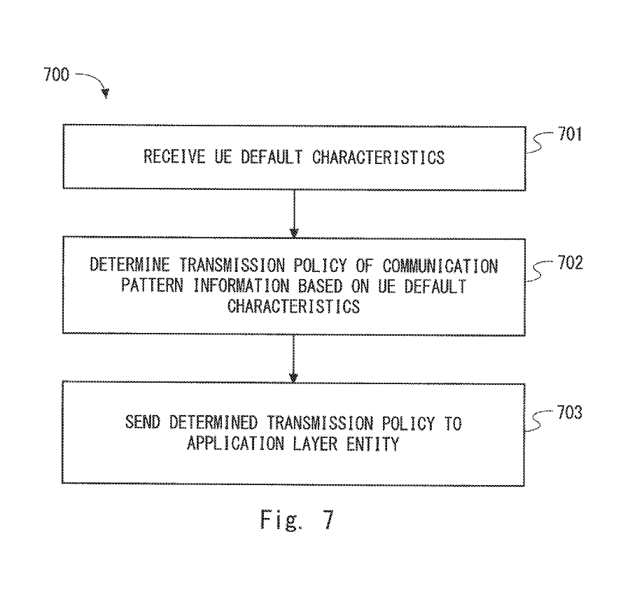

FIG. 7 is a flowchart showing an example (process 700) of a procedure for determining the transmission policy by the SCEF entity 1. In Block 701, the SCEF entity 1 receives the UE default characteristics. In Block 702, the SCEF entity 1 determines the transmission policy of the communication pattern information based on the UE default characteristics. In Block 703, the SCEF entity 1 sends the determined transmission policy to the one or more application layer entities 3.

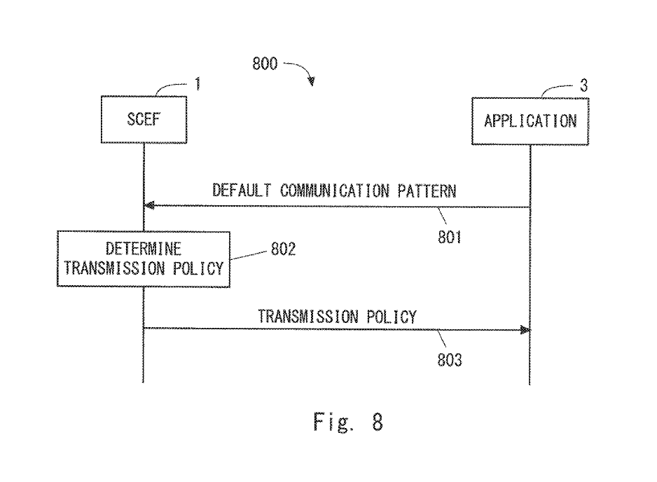

In some implementations, as shown in FIG. 8, the SCEF entity 1 may receive the UE default characteristics from the application layer entity(ies) 3. FIG. 8 is a sequence diagram showing an example (process 800) of a procedure for determining the transmission policy of the communication pattern information. In Block 801, the application layer entity 3 transmits the UE default characteristics (i.e., default communication pattern) to the SCEF entity 1 autonomously or in response to a request from the SCEF entity 1. In Block 802, the SCEF entity 1 determines the transmission policy of the communication pattern information to be applied to the UE based on the received UE default characteristics. In Block 803, the SCEF entity 1 sends the determined transmission policy to the application layer entity 3 that transmitted the UE default characteristics (801). The SCEF entity 1 may also send this transmission policy to other application layer entities 3.

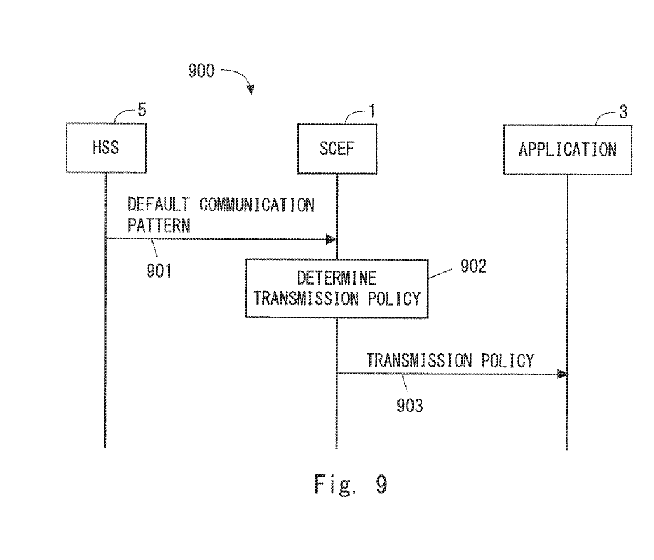

Alternatively, as shown in FIG. 9, the SCEF entity 1 may receive the UE default characteristics from the one or more network entities 2, specifically, from the HSS 5. The HSS 5 is a database (or subscriber server) that manages subscriber information regarding UEs.

FIG. 9 shows an example (process 900) of a procedure for determining the transmission policy of the communication pattern information. In Block 901, the SCEF entity 1 queries the HSS 5 and receives the UE default characteristics from the HSS 5. In Block 902, the SCEF entity 1 determines the transmission policy of the communication pattern information to be applied to the UE, based on the received UE default characteristics. In Block 903, the SCEF entity 1 transmits the determined transmission policy to the one or more application layer entities 3.

As understood from the above description, the SCEF entity 1 according to this embodiment is configured to receive the UE default characteristics and to determine the transmission policy of the communication pattern information based on the UE default characteristics. Accordingly, it is possible to enforce an appropriate transmission policy to the one or more application layer entities 3 in accordance with the UE default characteristics (i.e., characteristics in normal situations).

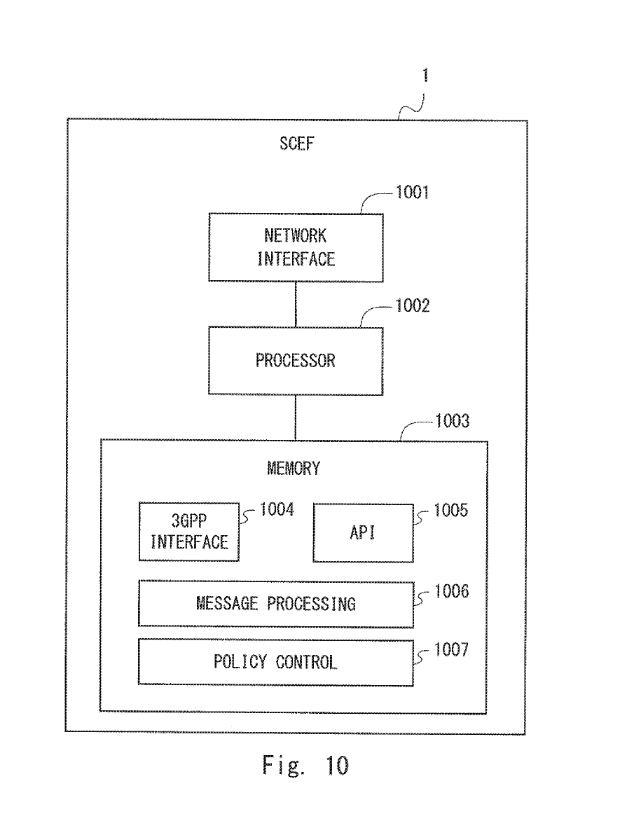

Lastly, a configuration example of the SCEF entity 1 according to the above-described embodiments will be described. FIG. 10 is a block diagram showing a configuration example of the SCEF entity 1. Referring to FIG. 10, the SCEF entity 1 includes a network interface 1001, a processor 1002, and a memory 1003. The network interface 1001 is used to communicate with the one or more network entities 2 and with the one or more application layer entities 3. The network interface 1001 may include a plurality of logical or physical interfaces. The network interface 1001 may include, for example, one or more network interface cards (NICs) conforming to the IEEE 802.3 series.

The processor 1002 loads software (computer program) from the memory 1003 and executes the loaded software, thereby executing the processing of the SCEF. The processor 1002 may be, for example, a microprocessor, a Micro Processing Unit (MPU), or a Central Processing Unit (CPU). The processor 1002 may include a plurality of processors.

The memory 1003 is composed of a combination of a volatile memory and a non-volatile memory. The volatile memory is, for example, a Static Random Access Memory (SRAM), a Dynamic RAM (DRAM), or any combination thereof. The non-volatile memory is, for example, a Mask Read Only Memory (MROM), a Programmable ROM (PROM), a flash memory, a hard disk drive, or any combination thereof. The memory 1003 may include a storage that is physically separated from the processor 1002. In this case, the processor 1002 may access the memory 1003 through the network interface 1001 or another I/O interface (not shown).

The memory 1003 may be used to store a software module(s) (computer program(s)) including instructions and data for executing the processing of the SCEF entity 1, which has been described in the above embodiments. In some implementations, the processor 1002 loads the software module(s) from the memory 1003 and executes the loaded software module(s), thereby performing the process of the SCEF entity 1, which has been described in the above embodiments.

More specifically, in the example of FIG. 10, the memory 1003 is used to store software modules including a 3GPP interface module 1004, an API module 1005, a message processing module 1006, and a policy control module 1007. The 3GPP interface module 1004 includes instructions and data for performing protocol processing on the 3GPP interfaces with the one or more network entities 2. The API module 1005 includes instructions and data for executing API protocol processing to communicate with the one or more application layer entities 3. The message processing module 1006 includes instructions and data for analyzing the communication pattern information and for performing processing to derive the network parameter(s). The policy control module 1007 includes instructions and data for generating the reception or transmission policy of the communication pattern information and for performing processing to enforce the reception or transmission policy. The processor 1002 loads these software modules from the memory 1003 and executes the loaded modules, thereby performing the process of the SCEF entity 1, which has been described in the above embodiments.

As described with reference to FIG. 10, the one or more processors included in the SCEF entity 1 according to the above embodiments execute one or more programs including a set of instructions that cause a computer to perform an algorithm(s) described above with reference to the drawings. These programs can be stored and provided to a computer using any type of non-transitory computer readable media. Non-transitory computer readable media include any type of tangible storage media. Examples of non-transitory computer readable media include a magnetic storage medium (such as a flexible disk, a magnetic tape, and a hard disk drive), an magneto-optical storage medium (e.g. a magneto-optical disk), a Compact Disc Read Only Memory (CD-ROM), a CD-R, a CD-R/W, and a semiconductor memory (such as a mask ROM, a Programmable ROM (PROM), an Erasable PROM (EPROM), a flash ROM, and a Random Access Memory (RAM)). These programs may be provided to a computer using any type of transitory computer readable media. Examples of transitory computer readable media include electric signals, optical signals, and electromagnetic waves. Transitory computer readable media can provide these programs to a computer via a wired communication line (e.g. electric wires, and optical fibers) or a wireless communication line.

### Other Embodiments

Each of the above embodiments may be used individually, or two or more of the embodiments may be appropriately combined with one another.

The above embodiments provide an example in which the communication pattern information is on a per-UE basis. However, the communication pattern information may be communication pattern information regarding a group of UEs. Further, the SCEF entity 1 may enforce the reception or transmission policy of the communication pattern information per group of UEs. For example, the groups of UEs may be defined based on the UE types or may be defined based on applications or services used by UEs.

The third embodiment described above provides an example in which the transmission policy of the communication pattern information is generated based on the UE default characteristics. Additionally or alternatively, the SCEF entity 1 may generate the reception policy of the communication pattern information based on the UE default characteristics.

Further, the above embodiments are merely examples of applications of the technical ideas obtained by the inventor. These technical ideas are not limited to the above embodiments and various modifications can be made thereto.

The present application is based upon and claims the benefit of priority from Japanese Patent Application No. 2015-069029, filed on Mar. 30, 2015, the disclosure of which is incorporated herein in its entirety by reference.

### REFERENCE SIGNS LIST

1 Service Capability Exposure Function (SCEF)
2 NETWORK ENTITY
3 APPLICATION LAYER ENTITY
4 NETWORK OPTIMIZATION CONTROLLER
5 Home Subscriber Server (HSS)

1-24. (canceled)

25. A control entity comprising:
a memory storing instructions; and
a processor configured to execute the instructions to:
communicate with at least one network entity in a mobile network;
inform a first entity comprising an Application Programming Interface (API) of a second information which controls a rate of transmission of a first information related to user data; and
receive the first information.

26. The control entity according to claim 25, wherein the second information is configured in the control entity.

27. The control entity according to claim 25, wherein the second information indicates a limit for the rate of the transmission of the first information, the first information generated by the first entity.

28. The control entity according to claim 25, wherein the second information causes the first entity to limit the rate of the transmission of the first information to comply with a rate indicated in the second information.

29. The control entity according to claim 27, wherein the processor is further configured to execute the instructions to discard the first information that exceeds the limit.

30. A method in a control entity, the method comprising:
communicating with at least one network entity in a mobile network;
informing a first entity comprising an Application Programming Interface (API) of a second information which controls a rate of transmission of a first information related to user data; and
receiving the first information.

31. The method according to claim 30, wherein the second information is configured in the control entity.

32. The method according to claim 30, wherein the second information indicates a limit for the rate of the transmission of the first information, the first information generated by the first entity comprising the API.

33. The method according to claim 30, wherein the second information causes the first entity to limit the rate of the transmission of the first information to comply with a rate indicated in the second information.

34. The method according to claim 32, further comprising discarding the first information that exceeds the limit.

35. A first entity comprising an Application Programming Interface (API), the first entity further comprising:
a memory storing instructions; and
a processor configured to execute the instructions to:
receive from a control entity a second information which controls a rate of transmission of a first information related to user data; and
send the first information based on the second information.

36. The first entity according to claim 35, wherein the second information is configured in the control entity.

37. The first entity according to claim 35, wherein the second information indicates a limit for the rate of the transmission of the first information, the first information generated by the first entity.

38. The first entity according to claim 35, wherein the processor is further configured to execute the instructions to limit the rate of the transmission of the first information to comply with a rate indicated in the second information.
